(19) United States
(12) Patent Application Publication
(10) Pub. No.: US 2018/0224818 A1
(43) Pub. Date: Aug. 9, 2018

(54) SYSTEM AND METHOD FOR AUTOMATICALLY CONTROLLING INTERNAL ENVIRONMENT AND VEHICLE'S INTERNAL ENVIRONMENT DEPENDING ON CHANGE IN INTERNAL/EXTERNAL ENVIRONMENTS

(71) Applicants: In Gi PEAK, Seoul (KR); DEAWANG SYSTEM CO., LTD, Daegu (KR)

(72) Inventor: In Gi PEAK, Seoul (KR)

(73) Assignees: DEAWANG SYSTEM CO., LTD, Daegu (KR); In Gi PEAK, Seoul (KR)

(21) Appl. No.: 15/487,778

(22) Filed: Apr. 14, 2017

(30) Foreign Application Priority Data
Feb. 3, 2017 (KR) 10-2017-0015699

(51) Int. Cl. G05B 19/048; B60R 16/037; F24F 11/00; B60H 1/00

(52) U.S. Cl. CPC G05B 19/048; B60R 16/037; F24F 2011/0063; B60H 1/008; G05B 2219/2642; F24F 11/006

(57) ABSTRACT

Disclosed herein are a system and method for automatically controlling an internal environment and a vehicle's internal environment depending on any change in an internal/external environment wherein every environmental value with respect to a change in an internal/external environment is collected, and a smart home system automatically controls related facilities based on a variable set value obtained by comparing the collected environment value with a recommended value regulated by the governments including the ministry of Environment, maintaining the optimum internal environment.

### CROSS REFERENCE TO PRIOR APPLICATION

This application claims priority to Korean Patent Application No. KR 10-2017-0015699 filed on Feb. 3, 2017, which is hereby incorporated by reference in its entirety.

### BACKGROUND

The present invention relates to a smart home system, and in particular to a system and method for automatically controlling an internal environment and a vehicle's internal environment depending on a change in internal/external environments wherein the optimum internal environment can be maintained without a user's manual operation in such a way that an internal/external environment value and a recommended standard value of the government are cross-compared.

The smart home system, in general, is referred to a technology which allows monitoring and controlling a variety of electronic devices in such a way to connect, through a communication network, a home appliance, for example, a TV, an air conditioner, a refrigerator, etc., and an energy consumption device, for example, a pipped water, an electricity, a heating and cooling device, etc., and a security device, for example, a door lock device, a monitoring camera, etc. The smart home system is a kind of a system which is able to automatically and remotely control such devices based on a user's preferences.

Needs for a human-oriented life environment promotion industry continue to increase, which is able to provide a convenient and comfortable life. Biomedical engineering and information communication technology are currently being developed; however an integrated service focusing on a user is not still enough.

Since a peoples' life style is changing to an internal life, a technology, method, device, etc. configured to make a people-oriented comfortable internal environment are receiving attention. Moreover, a variety of devices for making a comfortable internal environment are being provided at an internal home environment. In this case, it is hard to individually control each of the devices designed for a heating and cooling, moisturizing and air conditioning operations at a home space and a vehicle's internal environment.

Korea has four seasons. People in Korea use a cooling device and a cooling device. For a comfortable internal environment, the people are using an anion generator, a sterilizer, a moisturizer, etc.

The people may feel inconvenient since it needs to individually control each of such devices based on a user's preference, wherein the devices are configured to make a comfortable internal environment. A variety of internal dusts or bacteria may be spread since an external environment is not considered, and air-conditioning it is is common due to the over use of a cooling device. Any measure for a temperature difference between the internal and external environments is not prepared.

According to a prior art patent document, it describes a heath caring system, for example, a medical measuring device for measuring a blood pressure, blood sugar level, etc., a bath tub, and a messaging device, which is equipped with a plurality of network sensors arranged in a functionally and spatially partitioned area, a core access network configured to collect data from each sensor in a separate area, a central control server which is configured to receive an environment data including a temperature, a ventilation, a lighting, etc. from the core access network, a DB configured to store the collected environment data, and a controller provided to control an environmental condition including a temperature, a ventilation and a lighting in each area of a home and a vehicle's internal space, thus controlling the internal environment.

The conventional smart home technology can be adapted to an internal environment or one thing, so such a technology may become useless because it is impossible to take an appropriate action if a standard point changes due to the change to a surrounding environment. Since the conventional smart home technology is designed in a programmable way to each object, a people-oriented concentration and a combination of things are insufficient. For this reason, a more in-depth system design is necessary.

Furthermore, the environment information collected through a smart community is adapting an average value in the whole range of a corresponding area; however since the area to which the conventional technology applies, is limited to a part of the area, it needs to directly collect an external environment corresponding to the area.

For example, assuming that the distance between a building “A” near a park and a building “B” near a construction site is about 200 m, the fine dust index near the building “A” is 80 μg/m³, and the fine dust index near the building “B” is 300 μg/m³. As is seen in the above values, a local environmental deviation value is large even at the short distance.

For this reason, it urgently needs to develop a new system which is able to automatically make the optimum internal and vehicle's internal environment based on the recommended standard value of the government, not based on the environment comparison through the user's set information.

### PRIOR ART DOCUMENT

### Patent Document

Patent Document KR 10-0725943 B1

### SUMMARY

Accordingly, it is an object of the present invention to provide a system and method for automatically controlling an internal environment and a vehicle's internal environment depending on any change in an internal/external environment wherein every environmental value with respect to a change in an internal/external environment is collected, and a smart home system automatically controls related facilities based on a variable set value obtained by comparing the collected environment value with a recommended value regulated by the governments including the ministry of Environment, maintaining the optimum internal environment.

To achieve the above objects, there is provided a system for automatically controlling an internal environment and a vehicle's internal environment depending on an internal/external environments, which may include, but is not limited to, a smart home part configured to monitor and control related facilities through a terminal connected via a communication network; one or more related facilities configured to carry out a corresponding operation to control an internal environment in accordance with a control command of the smart home part; an internal environment collection part configured to collect an internal environment value by detecting an internal environment; an external environment collection part configured to collect an external environment value by detecting an external environment; a database part wherein the internal/external environment values collected by the internal/external environment collection parts are frequently stored, and a recommended value regulated by the ministry of the environment is previously stored; and a comparison setting part configured to provide a variable set value to the smart home part, wherein the variable set value is calculated by sequentially comparing the internal/external environment values and the recommended standard value for an automatic control of the related facilities in order for the internal environment to be appropriately maintained through the smart home part; and wherein the comparison setting part may include, but is not limited to, a first comparison part configured to calculate a comparison value by comparing the internal environment value of the internal environment connection part and the external environment value of the external environment collection part; and a second comparison part configured to calculate a variable set value by comparing the comparison value of the first comparison part and the recommended standard value of the database part.

There is further provided a power supply part configured to selectively supply, in case of a normal or emergency situation, a commercially available power for the driving of the related facilities and a generated power which uses a natural energy.

To achieve the above objects, there is provided a method for automatically controlling an internal environment and a vehicle's internal environment depending on an internal/external environments, which may include, but is not limited to, a collection step wherein internal/external environment values are collected in real time through internal/external environment collection parts, and the collected values are stored in a database part; a comparison part wherein a comparison value is calculated by first comparing the internal environment value and the external environment value through a first comparison part of a comparison setting part, and the comparison value and the recommended standard value regulated by the ministry of the environment are second compared through a second comparison part of the comparison setting part, thus calculating the optimum variable set value; and a control step wherein the related facilities are automatically controlled in order for the comfortable internal environment to be maintained without a user's operation through a smart home part to which the variable set value calculated through the comparison step has been provided.

The present invention allows providing a comfortable internal environment in such a way to set a smart home system based on a variable set value obtaining by sequentially comparing an internal environment value, an external environment value and a recommended standard value, thus automatically controlling related facilities without a user's operation.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating the configuration of a system for automatically controlling an internal environment and a vehicle's internal environment depending on any change in an internal/external environment according to the present invention; and

FIG. 2 is a flow chart for describing a method for automatically controlling an internal environment and a vehicle's internal environment depending on any change in an internal/external environment according to the present invention.

### DETAILED DESCRIPTION

The preferred embodiments of the present invention will be described with reference to the accompanying drawings to the extent that a person having ordinary skill in the art can easily implement the invention.

The system for automatically controlling an internal environment and a vehicle's internal environment depending on any change in an internal/external environment according to the present invention may include, but is not limited to an external environment collection part 200 configured to collectively collect an external environment value (EEV) in such a way to use a variety of sensors, for example, a temperature detection sensor, a moisture detection sensor, an illumination detection sensor, a smoke detection sensor, etc. and through a wireless sensor network (WSN), for example, a radio frequency identification (RFID), a ZigBee, a Wi-Fi, a Bluetooth, etc.

Moreover, an internal environment collection part 100 is provided inside so as to collectively collect an internal environment value (IEV), wherein the internal environment collection part 100 consists of the same components as the external environment collection part 200.

Furthermore, a database part 300 is provided inside, which is configured to store an external environment value EEV and an internal environment value IEV detected by the external environment collection part 200 and the internal environment collection part 100, and a previously set recommended standard value SV.

Here, the database part 300, as is seen in the following table, includes a set standard value SV which is referred to limiting the harmful substances to a set value range, for example, fine dusts, a carbon dioxide, a form aldehyde, a total suspended bacteria, a carbon monoxide, etc. in a public facility with respect to an internal air quality recommendation standard regulated by the ministry of environment.

The standard value SV is newly determined every year through a discussion by environment experts from a variety of fields, and the government accepts and announces the standard value. It is preferred that the database is updated from time to time through a firmware with the updated standard values.

TABLE 1

| | | | Form | Total | |
|---|---|---|---|---|---|
| Contamination | Fine | Carbon | al- | suspended | Carbon |
| substance item | dusts | dioxide | dehyde | bacteria | monoxide |
| Public facility | (μg/m³) | (ppm) | (μg/m³) | (CFU/m³) | (ppm) |
| Underground station | Below | Below | Below | | Below 10 |
| facility, | 150 | 1,000 | 100 | | |
| underground | | | | | |
| shopping center, | | | | | |
| waiting room at bus | | | | | |
| terminal, waiting | | | | | |
| room at rail station, | | | | | |
| passenger's | | | | | |
| terminal at airport | | | | | |
| facility, | | | | | |
| waiting room | | | | | |
| at port facility, | | | | | |
| library, museum and | | | | | |
| art gallery, funeral | | | | | |
| hall, bath house, | | | | | |
| large scale shop, | | | | | |
| movie theater, | | | | | |
| private educational | | | | | |
| institute, exhibit | | | | | |
| facility, business | | | | | |
| facility for the | | | | | |
| provision of internet | | | | | |
| computer game | | | | | |
| facility | | | | | |
| Medical institution, | Below | | | Below 800 | |
| children's house, | 100 | | | | |
| nursing facility for | | | | | |
| the aged, postnatal | | | | | |
| care center | | | | | |
| Indoor parking lot | Below | | | | Below 25 |
| | 200 | | | | |

TABLE 2

| | | | Total | | |
|---|---|---|---|---|---|
| | Nitro- | | volatile | As- | |
| Contamination | gen | | organic | bestos | |
| substance item | dioxide | Radon | compound | (pieces/ | Ozone |
| Public facility | (ppm) | (Bq/m³) | (μg/m³) | cc) | (ppm) |
| Underground station | Below | Below | Below 500 | Below | Below |
| facility, underground | 0.05 | 148 | | 0.01 | 0.06 |
| shopping center, | | | | | |
| waiting room at rail | | | | | |
| station, waiting | | | | | |
| room at passenger's | | | | | |
| bus terminal, waiting | | | | | |
| room at port facility, | | | | | |
| waiting room at | | | | | |
| airport facility, | | | | | |
| library, museum and | | | | | |
| art gallery, funeral | | | | | |
| hall, movie theater, | | | | | |
| private educational | | | | | |
| institute, exhibit | | | | | |
| facility, business | | | | | |
| facility for the | | | | | |
| provision of internet | | | | | |
| computer game | | | | | |
| facility, business | | | | | |
| facility at bath house | | | | | |
| B. Medical | | | Below 400 | | |
| institution, children's | | | | | |
| house, postnatal | | | | | |
| care center, nursing | | | | | |
| facility for the aged | | | | | |
| C. Indoor parking lot | Below | | Below | | Below |
| | 0.30 | | 1,000 | | 0.08 |

The internal/external environment values IEV and EEV detected by the external environment collection part 200 and the internal environment collection part 100 are compared in sequence with the recommended standard values SV stored in the database 300, thus changing a variable set value VSV so as to control the internal environment. The present invention provides a smart home part 500 configured to provide the optimum internal environment by automatically controlling, using the aforementioned variable set value VSV, the related facilities (which collectively means a variety of facilities, for example, water supply drainage, electricity, air conditioning facilities, etc. defined in the architecture), for example, a heating facility, a cooling facility, an air conditioning facility, a lighting facility, a crime prevention facility, a communication facility, a home appliance, etc.

The home smart technology is referred to a technology to control by connecting all the internal and external devices of the vehicle including a home appliance. More specifically, it is referred to a technology to monitor or control by connecting, through the communication network, all the related facilities in a variety of fields in addition to a home appliance product (a TV, an air conditioner, a refrigerator, etc.), an energy consumption device (a pipped water, electricity, cooling and heating, etc.), and a security device (a door lock, a security camera, etc.). The smart home can be automatically or remotely controlled based on a user's preference.

The present invention may provide at least one or more related facilities 400 which are configured to carry out a corresponding operation to control the internal environment in accordance with a control command of the smart home part 500.

Moreover, the database part 300 may store from time to time the internal/external environment values IEV and EEV collected by the internal/external environment collection parts 100 and 200, and a recommended standard value SV from the ministry of the environment may be previously stored in the database part 300.

Furthermore, the smart home part 500 may be equipped with a comparison setting part 700 configured to provide the variable set value VSV to the smart home part 500, wherein the variable set value can be calculated by sequentially comparing the internal/external environment values IEV and EEV and the recommended standard value SV so as to automatically control the related facilities 400 in order for the appropriate internal environment to be maintained through the smart home part 500.

The comparison setting part 700 may include a first comparison part 710 configured to compare the internal environment value IEV of the internal environment collection part 100 and the external environment value EEV of the external environment collection part 200, thus calculating a comparison value CV.

The environment condition that the user needs may be satisfied only with the comparison value CV calculated by the first comparison part 710, through which the related facilities 400 can be operated using the smart home part 500, thus adjusting the internal environment.

It may be difficult to maintain the internal environment in such a way to use only the comparison value CV since it greatly falls short of the recommended standard value SV, so the internal environment may be more worsened.

In this regard, there may be provided a second comparison part 702 configured to calculate a variable set value VSV by comparing the comparison value CV of the first comparison part 710 and the recommended standard value SV of the database 300 so as to automatically control the related facilities 400 by using the variable set value VSV as a basic data of the smart home part 500, thus obtaining the optimum internal environment.

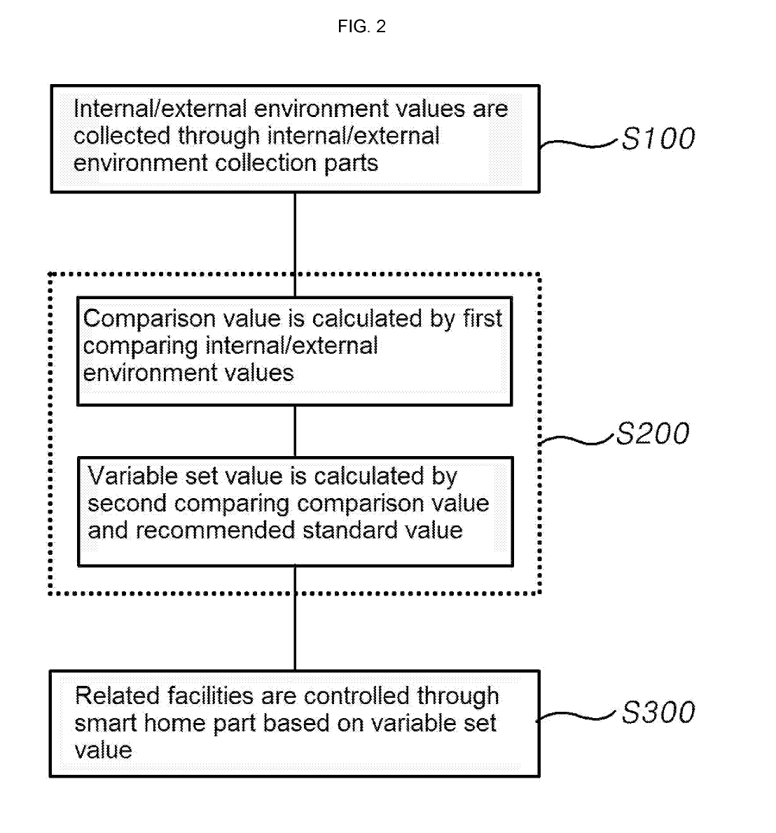

Referring to FIG. 2, the smart home part 500 will determine a comparison value CV by first comparing, through the first comparison part 710, the external environment value EEV and the internal environment value IEV, and the comparison value CV may be transmitted to the second comparison part 720 for a second comparison or may be transmitted to the smart home part 500 so as to operate a part of the related facilities 400.

The second comparison part 720 which has received the comparison value CV, will transmit a variable set value VSV to the smart home part 500, wherein the variable set value VSV has been determined by second comparing it with the recommended standard value SV of the database part 300, thus operating all the related facilities 400.

If the external temperature is 20° C., and the internal temperature is 25° C., and when the user needs 20° C. of the indoor temperature, the home smart part 500 at the first comparison will provide 20° C. of the indoor temperature in such a way to ventilate the external air in the inside by operating an air conditioning facility among the related facilities 400 or to open a window so as to satisfy the user's needs.

Meanwhile, if the external temperature corresponding to the external environment value EEV is 30° C., and the internal temperature corresponding to the internal environment value IEV is 28° C., the first comparison part 710 will determine a comparison value CV wherein the season is summer, and the difference between the internal/external temperatures is 2° C., and the second comparison part 720 will second compare the comparison value CV with the recommended standard value (according to the appropriate indoor temperature by season, the appropriate indoor temperature in summer is 22˜26° C., and the appropriate indoor temperature is winter is 18˜20°, and the difference between the internal/external environments is not higher than 4° C.).

The smart home part 500 will operate the devices closely related with the temperature, for example, a cooling facility, a blind, a circulation air conditioning, etc. among the related facilities 400 based on the variable set value VSV set through the comparison setting part 700, so the internal temperature can be automatically maintained at 26° C. without a user's operation.

More specifically, the variable set value VSV can be obtained based in the recommended standard value SV without a user's request or setting, in such a way that the external environment value EEV, the internal environment value IEV and the recommended standard value SV are sequentially compared or are cross-compared, by which the smart home part 500 can automatically operate the related facilities 400, thus maintaining an appropriate internal environment.

Alternatively, the variable set value VSV may be calculated in such a way to sequentially comparing a variety of internal environment values IEV, for example, the aforementioned temperature, the moisture, the setting of illumination, any motion of a person who comes in inside and goes out, a vehicle which comes in inside and goes out, and the temperature of a person who lives inside, the external environment value EEV, and the recommended standard value SV, and the calculated variable set value VSV will be provided as a basic information to the smart home part 500, thus automatically controlling the related facilities 400.

There may be further provided an emergency detection part, for example, an infrared ray detection sensor, a heart rate detection sensor, a sound detection sensor, etc. which are arranged inside in a non-contact type and are able to transfer any emergency situation to the smart home part 500, wherein the emergency situation may be an emergency situation, for example, a health problem, injuries, a blackout, etc. or an emergency situation, for example, an indoor fire, an intrusion, a robbery, etc.

More specifically, in case of the heart rate detection sensor, the user's state may be transmitted to the smart home part 500 through a wearable watch (for example, a smart watch) which has a wireless communication function, and in case of a domestic animal, the domestic animal's state may be transmitted to the smart hole part 500 through a communication chip embedded in a skin.

The smart home part 500 may be equipped with an emergency communication part which is configured to report any emergency situation by contacting an emergency contact previously stored in the database part 300 in accordance with a signal of the emergency detection part.

Meanwhile, there may be further provided a power supply part 600 which is able to supply power to the related facilities 400 in an emergency or non-emergency situation, which uses a solar battery, a wind power generator, as a power source 620 together with a commercially available power 610.

The smart home part 500 may include a data transmission part which is able to transmit an energy consumption quantity to a user's smartphone through each facility 400.

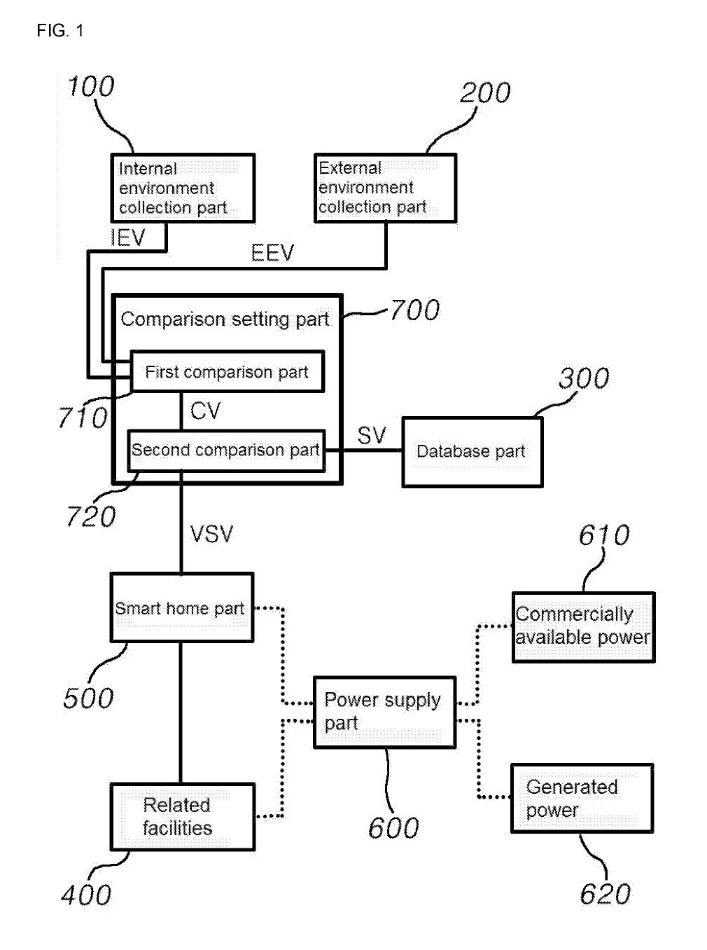

Referring to FIG. 1, the external environment collection part 200, which is installed outside, may include a temperature detection sensor configured to detect an outside temperature, a moisture detection sensor configured to detect moisture, an illumination detection sensor configured to detect illumination, and a smoke detection sensor configured to detect contamination, for example, smoke, dust and dirt, etc. In addition to them, various sensors may be provided, which are able to detect external environment values EEV.

The external environment collection part 200 may include a wireless sensor network, for example, a RFID, a ZigBee, a Wi-Fi, a Bluetooth, etc. which is able to detect a user's vehicle or portable terminal which makes an access from outside to inside.

The internal environment collection part 100, which is installed inside, may include a temperature detection sensor configured to detect an outside temperature, a moisture detection sensor configured to detect moisture, an illumination detection sensor configured to detect illumination, and a smoke detection sensor configured to detect contamination, for example, smoke, dust and dirt, etc. In addition to them, various sensors may be provided, which are able to detect internal environment values IEV.

Moreover, it is preferred that the internal environment collection part 100 may include a wireless sensor network which is configured to detect a portable terminal, a smart key, etc. like the external environment detection part 200 to monitor whether a user comes in inside, wherein the wireless sensor network may be wirelessly connected with home appliances.

The smart home part 500 may be equipped with an IoT technology (Internet of Things: it allows sharing information by connecting the things through the network in a variety of fields, for example, a home appliance and an electronic device as well as a health care, a remote meter reading, a smart home part 500, a smart car, etc.) to control the power supply and driving of all the related facilities 400, for example, a heating facility, a cooling facility, an air conditioning facility, a lighting facility, a crime prevention facility, a communication facility, home appliance, etc.

The smart home part 500 will compare the internal/external environment values IEV and EEV detected by the internal environment collection part 100 and the external environment collection part 200 with the recommended standard value SV stored in the database part 300.

The internal environment value IEV and the external environment value EEV with respect to all the things, for example, an internal environment, people, a mechanism, an animal and plant, a robot, a home appliance, etc. are sequentially compared, and a compared value CV will be stored in the database part 300, and at the same time, the variable set value VSV will be varied, thus controlling all the things, so an appropriate environment, for example, a temperature, a moisture, a lighting, etc. can be made.

If an internal environment appropriate to the variable set value VSV, which is a first comparison target, is not made in the aforementioned variable set value VSV, the variable set value VSV will be varied through a second comparison.

The smart home part 500 may generate a recommended standard value SV to set an appropriate variable set value VSV using all the things and may store it in the database part 300. An appropriate internal environment can be made in such a way to repeatedly carry out until the reach of a target value based on the variable set value VSV.

For example, a home temperature, moisture and lighting, a robbery, a fire, a boiler, a TV, an air conditioner, a boiler, an internet, a robot, a cleaning, clothes, the use of sun, wind power and natural recyclable energy, a vehicle, a medical service, a helper, a health state check, an automated vehicle driving, a report, a response, an answer, etc. may be automated in an artificial intelligence way.

It is obvious that the things, for example, an air conditioner, a humidifier, a boiler, an air purifier, a lighting device, etc. can be also automatically controlled in according to an indoor temperature, moisture, illumination, contamination which will be controlled.

Moreover, since one or more systems are provided, the indoor temperature, moisture, illumination, contamination, etc. can be automatically controlled without a user's operation in accordance with a control of the smart home part 500, thus providing an appropriate internal environment.

Furthermore, the smart home part 500 may be equipped with a timer to control, by time, the operations of the related facilities 400, for example, an air conditioner, a humidifier, a boiler, an air cleaner, a lighting device, a TV, a crime prevention system, a computer, and a washing machine. The contaminated indoor space may be cleaned based on the variable set value VSV by controlling the operations of a robot cleaner disposed inside. In addition, there may be provided a human body information detection sensor configured to detect a human body information including a human body blood pressure or body temperature through the emergency detection part. A result of the detection may be reported to a user in such a way to automatically dial a previously registered telephone number and automatically transmit a previously registered voice message.

The human body information including a blood pressure or body temperature used to determine any abnormal state of a human body may be registered in the smart home part 500. If the current user's body information is over a registered recommended standard value SV, the smart home part 500 will drive an emergency communication part and transmit a voice message containing a previously registered emergency state information to parents or guardian or a 119 emergency station, a police station, etc., so the emergency situation of a user, for example, an old man who lives alone, a patient, etc. can be appropriately handled.

Although the emergency detection part is not illustrated in the drawings, it is preferably configured in such a way that the user's body information, for example, a heart rate, a heart pulse, a blood pressure, etc. among the functions installed in a terminal, for example, a smart watch or a smart phone which is wearable to a user's body is detected, and a signal corresponding thereto will be wirelessly transmitted to the smart home part 500, so the user's indoor activity is not disturbed.

Moreover, there may be provided a meter reading sensor configured to read the quantity of use of an electricity, a city gas, a piped water, etc. including the operations of the related facilities 400, and an automatic dialing and data transmission part configured to automatically dial the previously registered telephone numbers of a meter reading office of an electricity, a city gas, a pipped water, etc. and to automatically transmit the read data. In this way, the quantity of use of the electricity, city gas or piped water will be transmitted to a user's portable terminal through the data transmission part of the smart home part 500, thus directly checking out without waiting for a meter reading date.

Furthermore, a predetermined charge, for example, a credit card payment, a bank transaction, etc. can be directly paid in such a way to transmit an energy consumption information to a corresponding office through a user's portable terminal.

As illustrated in FIG. 2, the method for automatically controlling an internal environment depending on any change in an internal/external environment may include, but is not limited to, a collection step S100 wherein internal/external environment values IEV and EEV are collected in real time through the internal/external environment collection parts 100 and 200 and are stored in the database part 300.

There may be provided a comparison step S200 wherein the first comparison part 710 of the comparison setting part 700 first compares the internal environment value IEV and the external environment value EEV, thus calculating a comparison value CV, and the second comparison part 720 of the comparison setting part 700 second compares the comparison value CV and the recommended standard value SV of the ministry of the environment, thus calculating the optimum variable set value VSV.

Moreover, there may be provided a control step S300 wherein the smart home part 500 to which the variable set value VSV calculated through the comparison step S200 has been provided, will automatically control the related facilities 400 in order for the comfortable internal environment to be maintained without any user's operation.

In addition to the temperature detection sensor, there may be provided a smoke detection sensor configured to detect any smoke. If the recommended standard value SV related with temperature and smoke concentration used to determine the occurrence of a fire is registered, the smart home part 500 may compare the temperature detected by the temperature detection sensor with the recommended standard value SV or may compare the smoke concentration detected by the smoke detection sensor with the recommended standard value SV. In this case, the emergency communication part will be driven, and a predetermined message or warning signal can be transmitted so as to report an emergency situation to a previously registered user or an emergency contact network, for example, a 119 station, a police office, etc. or a surrounding or friend's contact network, so the emergency situation can be handled without an inside user.

There may be provided a generated power 620 and a commercially available power 610, for example, a solar cell, a wind power generator, etc. so as to supply power to various sensors and things. The generated power 620 may be controlled to first supply power to the related facilities 400, for example, an air conditioner, a humidifier, a boiler, an air purifier, a lighting device, etc. in addition to various sensors in accordance with a command from the smart home part 500 in order to minimize the use of the commercially available power 610, thus saving a power energy.

In the aforementioned embodiments of the present invention, it has been described that the information, for example, a temperature, a moisture, an illumination, a contamination, a human body's information, a meter read information, smoke, etc. including power are compared, and the operations of the things, for example, an air conditioner, a humidifier, a boiler, an air purifier, a lighting device, a TV, a crime prevention system, a computer, a washing machine, a robot cleaner, etc. care automatically controlled; however the present invention is not limited thereto. Sensors for detecting oxygen and carbon dioxide may be provided to automatically control the driving of an oxygen generator. A camera for monitoring the circumference inside/outside the home may be installed. In this way, the driving of a thing, for example, a sensor and an electric and electronic device which are necessary based on surrounding environment and situation can be supplemented.

In the present embodiment of the present invention, it has been described that a variety of variable set values VSV and target values are registered in the smart home part 500; however the present invention is not limited thereto. The smart home part 500 may be provided with a communication module which is able to communicate with the outside, thus registering various variable set values VSV and target values. If necessary, the various set values or target values may be registered or modified or deleted from a distant place using a mobile device, for example, a smartphone. The user is able to monitor in real time the indoor environment and the vehicle's indoor environment which can be automatically controlled using a mobile device, for example, a smartphone.

If the embodiment of the present invention applies to a house, for example, a garden, a botanical garden, etc., the things can be automatically controlled based on an illumination, temperature, moisture, and health state so as to help a safe and efficient growth of plants through an appropriate illumination to plants and a plant watering, so the nutrition and moisture supply to the plants can be appropriately carried out.

As seen in table 1, the appropriate internal environment can be carried out by providing the above described system. The operation of the related facilities 400 will be described with the fine dust concentration based on one example wherein the indoor fine dust recommended standard value regulated by the ministry of the environment is 100 μg/m³.

First, assuming that a lot of people stay indoors at 3 P.M. when the weather is clear after rain, and the concentration of fine dusts outside is 100 μg/m³, and the concentration of the fine dusts inside is 200 μg/m³, the first comparison part 710 may determine that the concentration of the fine dusts inside is higher than the fine dusts outside, and the external circulation system is driven to input external air into the inside, thus reducing the concentration of the fine dusts inside, and the comparison value CV may have a difference of +20 μg/m³, wherein the concentration of the fine dusts does not drop below 120 μg/m³ by the people who stay inside, and the second comparison part 720 will drive the internal circulation system and the filter based on the variable set value VSV corresponding to −20 μg/m³ to below 100 μg/m³ which is the recommended standard value SV, so it can be automatically maintained below the recommended standard value SV.

Second, assuming that a small number of people stay indoors at 10 A.M. when the weather is foggy and mostly cloudy, and the concentration of fine dusts outside is 200 μg/m³, and the concentration of the fine dusts inside is 50 μg/m³, the first comparison part 710 will determine that the concentration of the fine dusts outside is higher than the inside and will close the external circulation system in order for the fine dusts outside the home not to enter the inside, and only the internal circulation system is driven so as to maintain a comfortable environment to the people who stay inside, and the second comparison part 720 will determine that the concentration is maintained at 100 μg/m³ by comparing with the recommended standard value SV, the operation of the internal circulation system is stopped, thus minimizing the power loss which may occur due to the operations of the related facilities.

Third, assuming that there is a lot of dusts due to a construction work at 3 P.M. when the weather is foggy and mostly cloudy, and the number of the people staying inside is over an appropriate number of the people who stay inside, and the concentration of fine dusts outside is 300 μg/m³, and the concentration of the fine dusts inside is 200 μg/m³, the first comparison part 710 will determine that the concentration of the fine dusts outside is higher than the inside, and will close the external circulation system in order for the external fine dusts not to enter the inside, and the internal circulation system will be driven to maintain a comfortable environment to the people who stay inside, and the second comparison part 720 will further drive the air purifier inside after considering that the concentration of the fine dusts inside is +100 μg/m³ as compared to the recommended standard value SV, thus maintaining 100 μg/m³ of the fine dust concentration which corresponds to the recommended standard value SV.

Fourth, assuming that there is not any people inside a building at 2 A.M. when the weather is clear after rain, and the concentration of fine dusts outside is 100 μg/m³, and the concentration of the fine dusts inside is 100 μg/m³, the first comparison part 710 will determine that there is not any difference in the fine dust concentrations inside and outside, so both the internal circulation system and the external circulation system don't operate, and the second comparison part 720 will determine that there is not any difference after comparing with the recommended standard value SV, so both the internal circulation system and the external circulation system don't operate, thus minimizing the power consumption which may occur due to the operations of the systems.

More specifically, while only the fin dusts have been described as an example among many environmental factors for easier understanding of the operation, more complicated internal environments can be improved through the application of the recommended standard value SV with respect to various substances regulated by the ministry of the environment, and all the operation related thereto will be automatically carried out.

Moreover, if the present invention applies to the domestic animal farm, a health state, for example, a body temperature, a heart rate, a waste, etc. may be monitored for an appropriate growth of the animal, and a medicine treatment, excrements removal, a feeding, etc. can be automatically carried out. Furthermore, if an abnormal state occurs, a predetermined information can be transmitted to a user's portable terminal. In this way, the system can be designed in order for such operations to be adapted to the related automated facilities.

In the present invention, the comfortable internal environment of the related facilities 400 can be automatically obtained without a user's operation in cooperation with the comparison of the internal environment value IEV and the external environment value EEV. It is possible to quickly handle with the indoor emergency situation or emergency situation, and the quantity of use of the indoor energy use can be monitored at a time, and the quality of use of the commercially available power 610 can be minimized.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A system for automatically controlling an internal environment and a vehicle's internal environment depending on an internal/external environments, comprising:
a smart home part configured to monitor and control related facilities through a terminal connected via a communication network;
one or more related facilities configured to carry out a corresponding operation to control an internal environment in accordance with a control command of the smart home part;
an internal environment collection part configured to collect an internal environment value (IEV) by detecting an internal environment;
an external environment collection part configured to collect an external environment value (EEV) by detecting an external environment;
a database part wherein the internal/external environment values (IEV and EEV) collected by the internal/external environment collection parts are frequently stored, and a recommended value (SV) regulated by the ministry of the environment is previously stored; and
a comparison setting part configured to provide a variable set value (VSV) to the smart home part, wherein the variable set value is calculated by sequentially comparing the internal/external environment values (IEV and EEV) and the recommended standard value (SV) for an automatic control of the related facilities in order for the internal environment to be appropriately maintained through the smart home part; and
wherein the comparison setting part includes:
a first comparison part configured to calculate a comparison value (CV) by comparing the internal environment value (IEV) of the internal environment connection part and the external environment value (EEV) of the external environment collection part; and
a second comparison part configured to calculate a variable set value (VSV) by comparing the comparison value (CV) of the first comparison part and the recommended standard value (SV) of the database part.

2. The system of claim 1, further comprising:
a power supply part configured to selectively supply, in case of a normal or emergency situation, a commercially available power for the driving of the related facilities and a generated power which uses a natural energy.

3. A method for automatically controlling an internal environment and a vehicle's internal environment depending on an internal/external environments, comprising:
a collection step wherein internal/external environment values (IEV and EEV) are collected in real time through internal/external environment collection parts, and the collected values are stored in a database part;
a comparison part wherein a comparison value (CV) is calculated by first comparing the internal environment value (IEV) and the external environment value (EEV) through a first comparison part of a comparison setting part (700), and the comparison value (CV) and the recommended standard value (SV) regulated by the ministry of the environment are second compared through a second comparison part of the comparison setting part, thus calculating the optimum variable set value (VSV); and
a control step wherein the related facilities are automatically controlled in order for the comfortable internal environment to be maintained without a user's operation through a smart home part to which the variable set value (VSV) calculated through the comparison step has been provided.
